(19) United States
(12) Patent Application Publication
(10) Pub. No.: US 2005/0122992 A1
(43) Pub. Date: Jun. 9, 2005

(54) Device, system, method and program for information processing, recording medium storing the program

(75) Inventors: Yukio Numakami, Tokorozawa-shi (JP); Kenichiro Tada, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/983,961

(22) Filed: Nov. 9, 2004

(30) Foreign Application Priority Data
Nov. 12, 2003 (JP) 2003-382925

(51) Int. Cl. H04J 3/16

(52) U.S. Cl. 370/468; 386/1

(57) ABSTRACT

There are provided a DVD drive for recording information being able to be reproduced in a DVD, a designated information generator (431) for generating a play list, a designated information transmitter (432) for transmitting the play list to destination(s) being set, a destination information register (434) in which destination information has been registered, a designated information receiver for receiving a play list transmitted from other device(s) for information processing, an information existence judging section (435) for judging whether information being specified by the information specifying data of the received play list has been recorded in the DVD or not, and an information reproducer (436) for reproducing information based on the received play list, in the case that the information existence judging section (435) confirmed that the information had been recorded.

### BACKGROUND OF THE INVENTION

1. Field of the Invention

The present invention relates to a device, a system, a method and a program for information processing in which data such as image data, voice data and music data are processed, and a recording medium storing the program.

2. Description of Related Art

As a medium for recording video data and audio data of broadcast contents, a videotape has been used for a long time. However, recently, a recording medium capable of random access, such as a CD (compact disk), a DVD (digital versatile disk), a hard disk and a semiconductor memory, has been used.

Some recording medium utilizes a play list function in which a user connects only specific scenes in recorded data and reproduces the scenes by utilizing the random access feature.

The play list function is a function that makes list information (meta data) in which information (mark, chapter) showing the starting position and the ending position of the data desired to be reproduced in the recorded data is arranged, and sequentially reproduces the specified data corresponding to the play list without any edition for recorded original data. Thereby, the user can freely reproduce the data by using the play list function.

Generally, the play list is made on the data recorded in an apparatus used by the user himself/herself. However, when many persons come to use the recording-media capable of random access, it may be conceivable that there is a demand for the offering of his/her own made play list to other persons who recorded the same contents.

There have been disclosed systems for making other users use information of broadcast contents individually edited by each of users by delivering the information (refer to, for example, Document 1: Japanese Patent Laid-Open Publication No. 2003-18529 (Paragraph No. 0003), and Document 2: Japanese Patent Laid-Open Publication No. 2003-61023 (Paragraph No. 0002 and 0003)).

In the documents 1 and 2, it is described that at least two video broadcast receiving and recording apparatuses and at least one server are provided on a network, and on the server there are provided a customer database in which the video broadcast receiving and recording apparatuses and their users are registered, and a video database in which the users can register reproducing position information (meta data). And the plural video broadcast receiving and recording apparatuses existing on the network register the meta data to the server and also obtain the meta data. Thereby other users can use the meta data edited by a user, by obtaining the meta data from the server.

However, in the documents 1 and 2, there is a problem that a server is required in addition to the plural video broadcast receiving and recording apparatuses as an example. Especially, in many cases, receiving and offering the play list is executed among friends and acquaintances having a common hobby, therefore it is difficult to provide a server in such a narrow community and manage the server. Therefore, there is a problem that it is difficult to realize the system.

### SUMMARY OF THE INVENTION

An object of the present invention is to provide a device, a system, a method and a program for information processing, and a recording medium storing the program, in which other users can utilize data edited by a user without using a server.

An aspect of the present invention is to provide a device for information processing in a plurality of devices for information processing, which are connected to one another via a network, the device including: an information recorder for recording information being able to be reproduced in an information recording medium, a designated information generator for generating designated information having information specifying data for specifying information, reproducing section data and reproducing order data in the specified information, a designated information transmitter for transmitting the generated designated information to a destination(s) being set, a destination information register in which destination information has been registered, a designated information receiver for receiving designated information transmitted from other devices for information processing, an information existence judging section for judging whether the information being specified by the information specifying data of the received designated information has been recorded in the information recorder or not, and an information reproducer for reproducing information based on the received designated information, in the case that the information existence judging section has confirmed that the information had been recorded.

Another aspect of the present invention is to provide a system for information processing, the system including the aforesaid devices for information processing and a network for connecting the devices for information processing to one another.

A further aspect of the present invention is to provide a method for information processing being executed among a plurality of devices for information processing connecting to one another via a network, the method including the steps of: receiving designated information having information specifying data for specifying information, reproducing section data and reproducing order data in the specified information, judging whether information being specified by the information specifying data of the received designated information has been recorded or not in an information recorder for recording information being able to be reproduced in an information recording medium, and reproducing information based on the received designated information when it was confirmed that the information had been recorded.

Still another aspect of the present invention is to provide a method for information processing being executed among a plurality of devices for information processing connecting to one another via a network, wherein the method includes, at one device in the plurality of devices for information processing, the steps of: generating designated information having information specifying data for specifying information, reproducing section data and reproducing order data in the specified information, and transmitting the generated designated information to a destination(s) being other device(s) in the plurality of devices for information processing; and wherein the method includes, at other device(s) in the plurality of devices for information processing, the steps of: registering information of the destination information, receiving the designated information transmitted from the one device, judging whether information being specified by the information specifying data of the received designated information has been recorded or not in an information recorder for recording information being able to be reproduced in an information recording medium, and reproducing information based on the received designated information, when it was confirmed that the information had been recorded.

Still another aspect of the present invention is to provide a program for information processing executing the aforesaid methods for information processing.

Yet another aspect of the present invention is to provide a recording medium storing the aforesaid program for information processing in a manner readable by a computer.

### BRIEF DESCRIPTION OF THE DRAWINGS

FIG. 1 is a schematic block diagram showing a system for information processing in an embodiment of the present invention;

FIG. 2 is a schematic block diagram showing an internal structure of a device for information processing;

FIG. 3 is a schematic block diagram showing an internal structure of a CPU in the device for information processing;

FIG. 4 is a diagram showing a structure of a play list;

FIG. 5 is a schematic diagram showing a structure of “PGC” in a table form;

FIG. 6 is a schematic diagram showing a structure of “CI” in a table form;

FIG. 7 is a schematic diagram showing a structure of “M_C_EPI” in a table form;

FIG. 8 is a schematic diagram showing a structure of a VOB recognition field in a table form;

FIG. 9 is a schematic diagram showing a structure of VOB recognition information in a table form;

FIG. 10 is a schematic diagram showing a structure of an information recipient list in a table form;

FIG. 11 is a schematic diagram showing a structure of information recipient data in a table form;

FIG. 12 is an operation sequence chart of the three devices for information processing;

FIG. 13 is a flowchart showing processes of communication of a video recording by multi-address communication

FIG. 14 is a schematic diagram showing a structure of a changed VOB recognition field in a table form;

FIG. 15 is a schematic diagram showing a structure of changed VOB recognition information in a table form;

FIG. 16 is a schematic diagram showing a structure of a changed information recipient list in a table form;

FIG. 17 is a schematic diagram showing a structure of changed information recipient data in a table form;

FIG. 18 is a schematic diagram showing a message on a screen of an e-mail;

FIG. 19 is a flowchart showing processes of reception of a video recording by multi-address communication

FIG. 20 is a schematic diagram showing a structure of a changed VOB recognition field in a table form;

FIG. 21 is a schematic diagram showing a structure of changed VOB recognition information in a table form;

FIG. 22 is a schematic diagram showing a structure of a changed information recipient list in a table form;

FIG. 23 is a schematic diagram showing a structure of changed information recipient data in a table form;

FIG. 24 is a flowchart showing processes of notification of execution of a control code;

FIG. 25 is a schematic diagram showing a message on a screen of an e-mail;

FIG. 26 is a schematic diagram showing a structure of a changed VOB recognition field in a table form;

FIG. 27 is a schematic diagram showing a structure of changed VOB recognition information in a table form;

FIG. 28 is a schematic diagram showing a structure of a changed information recipient list in a table form;

FIG. 29 is a schematic diagram showing a structure of changed information recipient data in a table form;

FIG. 30 is a flowchart showing processes of reception of recording execution communication by an information receiving person;

FIG. 31 is a schematic diagram showing a structure of a changed VOB recognition field in a table form;

FIG. 32 is a schematic diagram showing a structure of changed VOB recognition information in a table form;

FIG. 33 is a schematic diagram showing a structure of a changed information recipient list in a table form;

FIG. 34 is a schematic diagram showing a structure of changed information recipient data in a table form;

FIG. 35 is a flowchart showing processes of communication of a play list;

FIG. 36 is a schematic diagram showing a message on a screen of an e-mail;

FIG. 37 is a flowchart showing processes of reception of a play list;

FIG. 38 is a schematic diagram showing a structure of changed “PGC” in a table form;

FIG. 39 is a schematic diagram showing a structure of changed “CI” in a table form; and

FIG. 40 is a schematic diagram showing a structure of changed “M_C_EPI” in a table form;

### DETAILED DESCRIPTION OF PREFERRED EMBODIMENT(S)

Referring now to the drawings, an embodiment of the present invention will be explained. In the embodiment of the present invention, though a video recording system by multi-address communication in which a recording reservation for a TV program, for example, is set in a device for information processing, will be explained, the system is not limited thereto, but may be otherwise system such as a sound recording system with multi-address communication in which a recording reservation for a radio program is set in the device for information processing. Furthermore, in the system, information such as video data and programs can be processed in the same way.

[Configuration of Video Recording System by Multi-Address Communication]

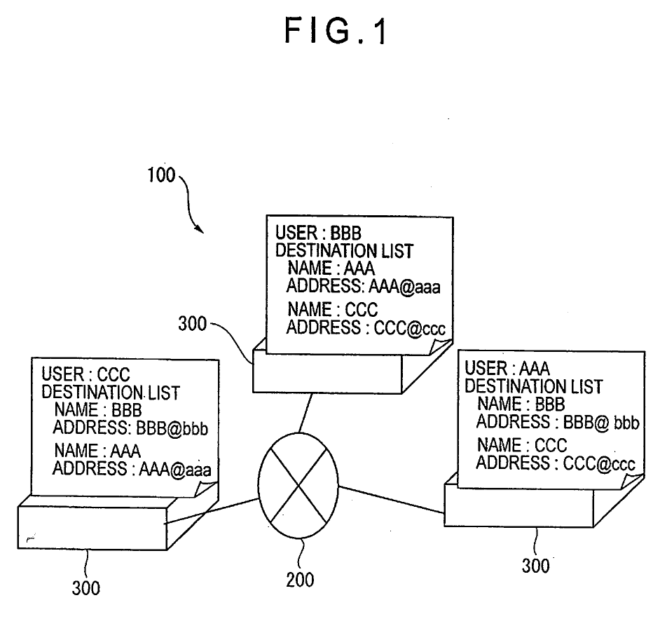

FIG. 1 is a schematic block diagram showing a system for information processing in the embodiment of the present invention.

In FIG. 1, a video recording system by multi-address communication 100 is the system for information processing, and the video recording system by multi-address communication 100 is comprised of a network 200, and a first to a third devices for information processing 300 connecting to the network 200. Here, a structure in which three devices for information processing 300 are provided in the video recording system by multi-address communication 100 is used for the explanation as an example. However, the number of the devices for information processing 300 is not limited to three, but can be two, or more than three.

As the network 200, for example, a LAN (local area network) such as an intranet, an extranet, and the Ethernet (registered trademark), based on a general purpose protocol such as the TCP/IP (Communication Control Protocol/Internet Protocol) can be used. Further, as the network 200, a network such as a communication network which is composed of a plurality of base stations capable of transmitting and receiving data by radio medium, and a broadcast network can be used. Here, as the radio medium, any one of media such as a radio wave, light, a sound wave, and an electromagnetic wave, can be used.

Each of the first to third devices for information processing 300 is a recording and reproducing device by the DVD-VR (DVD video recording) system, and data of group authentication and group user authentication have been registered in the device. And the device for information processing 300 is capable of receiving multi-address communicated recorded data by use of an e-mail and the like, and can identify contents recorded by the video recording by use of multi-address communication.

In the first device for information processing 300, the name of the user (AAA) and a destination list are recorded for transmitting and receiving data by e-mails. In the destination list, the name (BBB) and the e-mail address (BBB@bbb) of the user of the second device for information processing 300 and the name (CCC) and the e-mail address (CCC@ccc) of the user of the third device for information processing 300 are recorded.

In the same way, in the second device for information processing 300, the name of the user (BBB) and a destination list are recorded for transmitting and receiving data by e-mails. In the destination list, the name (AAA) and the e-mail address (AAA@aaa) of the user of the first device for information processing 300 and the name (CCC) and the e-mail address (CCC@ccc) of the user of the third device for information processing 300 have been recorded.

In the same way, in the third device for information processing 300, the name of the user (CCC) and a destination list are recorded for transmitting and receiving data by e-mails. In the destination list, the name (AAA) and the e-mail address (AAA@aaa) of the user of the first device for information processing 300 and the name (BBB) and the e-mail address (BBB@bbb) of the user of the second device for information processing 300 have been recorded.

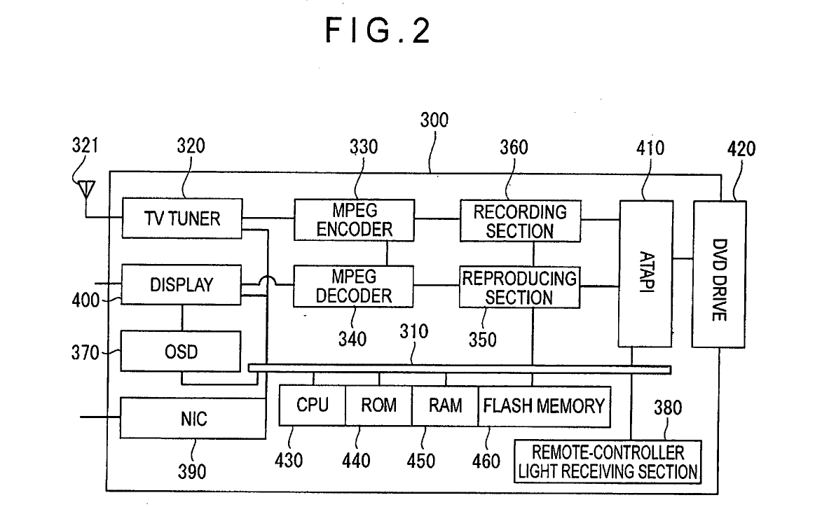

FIG. 2 is a schematic block diagram showing the internal structure of the first device for information processing 300. Incidentally, since the second device for information processing 300 and the third device for information processing 300 have the same structure that the first device for information processing 300 has, the same explanation is omitted.

In FIG. 2, the device for information processing 300 may be, for example, a recorder such as a hard disk recorder and a hard disk built-in type DVD (digital versatile disk) recorder.

The device for information processing 300 executes recording and reproducing a TV program as information, by inputting operation with a remote controller (not shown) and operating buttons (not shown).

The device for information processing 300 includes a bus 310, a TV tuner 320, an MPEG encoder 330, an MPEG decoder 340, a reproducing section 350, a recording section 360, an OSD (on screen display) 370, a remote-controller light receiving section 380, a NIC (network interface) 390, a display 400, an ATAPI 410, a DVD drive 420, a CPU 430, a ROM 440, a RAM 450, a flash memory 460 and the like.

The bus 310 may be, for example, a bus such as a PCI (peripheral component interconnect) bus, or an IEEE (Institute of Electrical and Electronic Engineers) 1394 bus. Connected to the bus 310 are the TV tuner 320, the MPEG encoder 330, the MPEG decoder 340, the reproducing section 350, the recording section 360, the OSD 370, the remote-controller light receiving section 380, the NIC 390, the display 400, the ATAPI 410, the CPU 430, the ROM 440, the RAM 450, the flash memory 460 and the like.

To the TV tuner 320, an antenna 321 for receiving broadcast programs is connected. And the TV tuner 320 is connected to the MPEG encoder 330. Further, the TV tuner 320 is connected to the CPU 430 via the bus 310. The TV tuner 320 obtains signals, which were received by the antenna 321 and inputted to the TV tuner 320, under the control of the CPU 430. And the signals are outputted to the MPEG encoder 330 after the signals being appropriately converted.

The MPEG encoder 330 is an encoder of the MPEG (moving picture experts group) system, and encodes the signals sent from the TV tuner 320 and sends the encoded signals to the recording section 360. The recording section 360 records the signals sent from the MPEG encoder 330 and send the signals to the ATAPI 410.

The ATAPI 410 is an interface provided between the recording section 360 and the DVD drive 420, and between the reproducing section 350 and the DVD drive 420.

The reproducing section 350 reproduces signals sent from the DVD drive 420 via the ATAPI 410 and the reproduced signals are sent to the MPEG decoder 340. The MPEG decoder 340 obtains video data described in the signals inputted from the reproducing section 350 under the control of the CPU 430. And the obtained video data are decoded as a video stream, appropriately converted to the process signals, and outputted to the display 400.

The OSD 370 is connected to the display 400. And also the OSD 370 is connected to the CPU 430 via the bus 310. The OSD 370 obtains process signals inputted from the CPU 430, for example, process signals described information such as, adjusting state information and operating state information of the display 400 and information that urges to input a setting whether a video recording reservation is accepted or not, under the control of the CPU 430. And the OSD 370 appropriately converts the various information described in the obtained process signals into OSD signals. After this, the OSD 370 outputs the converted OSD signals to the display 400 and makes the display 400 display the information on the video stream by adding the information appropriately.

The remote-controller light receiving section 380 is connected to the CPU 430 via the bus 310. The remote-controller light receiving section 380 receives an instruction such as an instruction for setting a general video recording reservation by receiving light such as infrared rays outputting from a remote controller (not shown). And the remote-controller light receiving section 380 converts signals which the infrared rays have into process signals appropriately and outputs the converted signals to the CPU 430.

The NIC 390 is connected to other devices for information processing 300 via the network 200, and also is connected to the CPU 430 via the bus 310.

In the ROM 440, device management information (for example, ID number of the device) and other information have been stored.

The DVD drive 420 is an information recording section for recording information capable to be reproduced in a data recording medium such as a DVD (not shown). By the DVD drive 420, a broadcast program received by the antenna 321 and program specifying data for specifying the broadcast program are recorded in the recording medium such as the DVD.

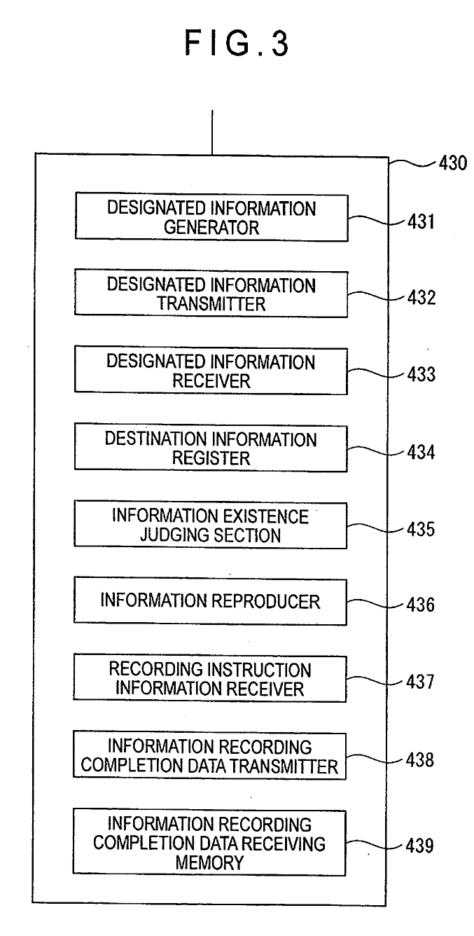

FIG. 3 is a schematic block diagram showing the structure of the CPU 430. In FIG. 3, the CPU 430 comprises a designated information generator 431, a designated information transmitter 432, a designated information receiver 433, a destination information register 434, an information existence judging section 435, an information reproducer 436, a recording instruction information receiver 437, an information recording completion data transmitter 438, and an information recording completion data receiving memory 439.

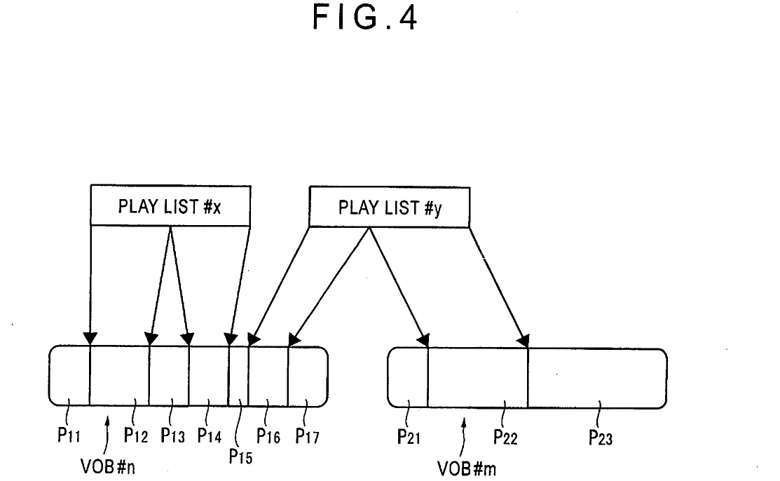

The designated information generator 431 generates a play list as designated information. This play list is a list in which the order of programs, which a user desires to record and reproduce in video broadcast programs, is designated, and the play list has the structure showing in FIG. 4. In FIG. 4, play lists #x and #y are generated by designating the order of programs P12, P14, P16, and P22 which a user desires to record and reproduce in programs P11 to P17 of VOB #n showing broadcast programs (video objects) and programs P21 to P23 of VOB #m. And each of the play lists #x and #y has program specifying data (cells), and reproducing section data and reproducing order data in the specified information. Incidentally, the VOB #m showing a broadcast program (video object) signifies one work, and its number is different in each of the devices for information processing 300.

Herein, the program specifying data provides channel data specifying a broadcasting station, program starting data specifying program starting date and time, and program ending data specifying program ending date and time.

In FIG. 3, the designated information transmitter 432 transmits a play list to destinations set by a user via the NIC 390, by attaching to an e-mail M.

The designated information receiver 433 receives play lists transmitted respectively from the other two devices for information processing 300.

In the destination information register 434, destination information, that is, names of users of the other two devices for information processing 300 and their e-mail addresses, control code ID numbers, and other data, has been registered in advance.

The information existence judging section 435 judges whether information specified by the information specifying data of the received play list has been recorded in the information recording section or not.

The information reproducer 436 transmits an instruction for reproducing the information to the DVD drive 420 via the ATAPI 410 based on the received play list, in the case that the information existence judging section 435 confirmed that the information had been recorded.

The recording instruction information receiver 437 receives recording instruction information including recording control data instructing to record a program, identifying data for identifying the recording control data, originator data showing the originator who transmitted the recording instruction information, and destination data having sender data showing the sender who sent the recording instruction information. And based on the received recording instruction information, a designated program, the identifying data, and other data are recorded in the DVD drive 420.

In the DVD drive 420, the information recording completion data transmitter 438 transmits, when the information recording process was executed and completed based on the recording instruction information, information recording process completion data having the identifying data and the process completion data in the recording instruction information to each of the destinations recorded in the destination data.

The information recording completion data receiving memory 439 receives the information recording process completion data from the other two devices for information processing 300 and memorizes the originator data and the identifying data.

At this time, the designated information transmitter 432 sets the sender data of the sender who transmitted the information recording process completion data, which includes the identifying data corresponding to the information specified data of the designated information to be transmitted, as the destination, and transmits the designated information.

Next, the data structure of the CPU 430 is explained by using diagrams showing in a table form.

In the DVD-VR standard used in the embodiment of the present invention, PGC (program chain) and cell are defined so that the time structure and the order of real time data to be reproduced can be set freely. And an individual ID number (CI) is attached to the cell in the reproducing unit of the real time data. The PGC designates the reproducing order of the cell. In the embodiment of the present invention, the framework of MNFI (manufacturer information) of the DVD-VR is used for the structure of the play list. This MNFI is a region that each of the manufactures can use freely.

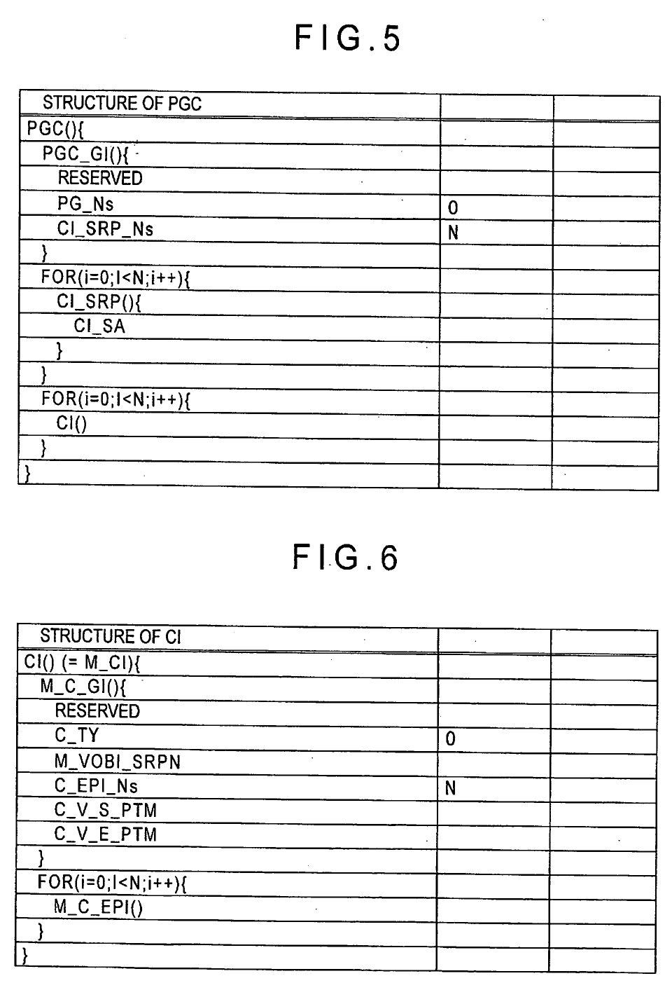

FIG. 5 to FIG. 7 are schematic diagrams showing the structure of the PGC in a table form. Incidentally, in these diagrams, only a play list for moving picture contents is explained.

As shown in FIG. 5, the PGC has the same main structure as the conventional technology has, and has a large field called as “PGC” in a part of the structure, and this “PGC” has a field called as “PGC_GI”, and fields called as “CI_SRP” and “CI”.

The structure of the “CI” is shown in FIG. 6. In FIG. 6, the “CI” has fields called as “M_C_GI” and “M_C_EPI”.

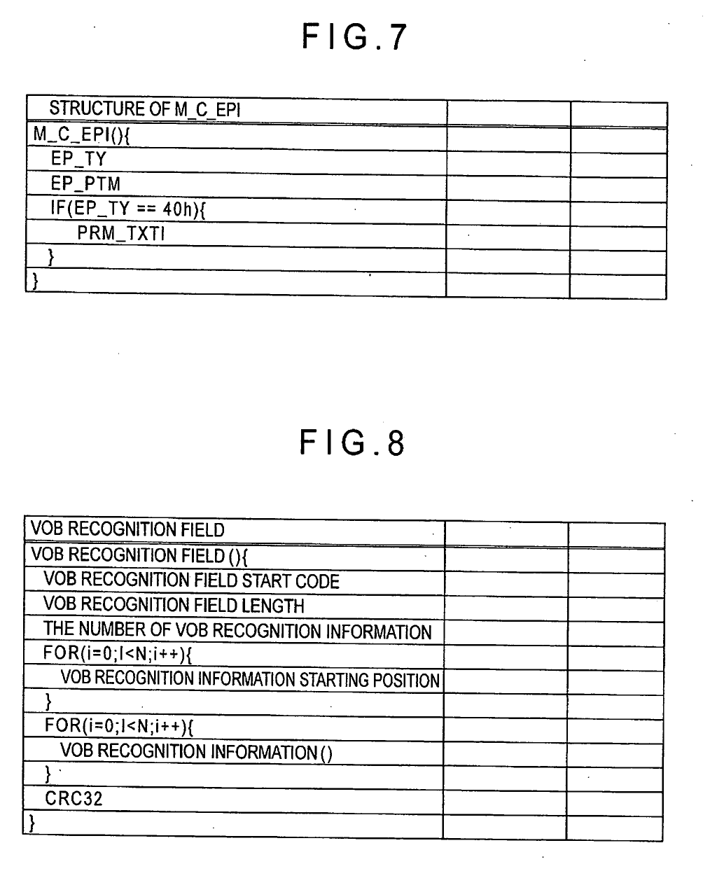

The structure of the “M_C_EPI” is shown in FIG. 7. In FIG. 7, the “M_C_EPI” has fields called as “EP_TY” and “EP_PTM”.

In the framework of the management of contents in the embodiment of the present invention, the recorded VOB number and the program number are changed depending on the state of the DVD disk at the time of recording. That is, even when the plural devices for information processing 300 recorded some contents at the same time by pulling a trigger, the same contents were not always recorded as the same VOB and the same program. Therefore, in addition to the VOB number and the program number, a structure, which can recognize that the same contents were recording by the plural devices for information processing 300 by the same trigger, is required. In order to meet this, in the embodiment of the present invention, in order to recognize that the contents recorded by the same trigger are the same, a structure in which additional information is attached to the VOB is adopted.

Referring to FIG. 8 to FIG. 11, the structure in which additional information is attached to the VOB is explained.

FIG. 8 is a schematic diagram showing the structure of a VOB recognition field in a table form.

In FIG. 8, the VOB recognition field has a field called as “VOB recognition field start code”, a field called as “VOB recognition field length”, a field called as “the number of VOB recognition information”, a field called as “VOB recognition information starting position”, a field called as “VOB recognition information”, and a field called as “CRC32”.

Herein, the “VOB recognition field start code” can be set by an operator, and is stored with, for example, data “PIONEER_COMMUNITY_APPLI_FIELD_{—}00”.

The “VOB recognition field length” describes the number of total bytes of the VOB recognition field, the “the number of VOB recognition information” describes the number of VOB recognition information, the “VOB recognition information starting position” describes the start position of the VOB recognition information having an indefinite length and has a few VOB recognition information arranged in line. Generally, the number of bytes from the head of the VOB recognition field is described.

The “CRC32” is used for preventing the alteration of the total data in the VOB recognition field.

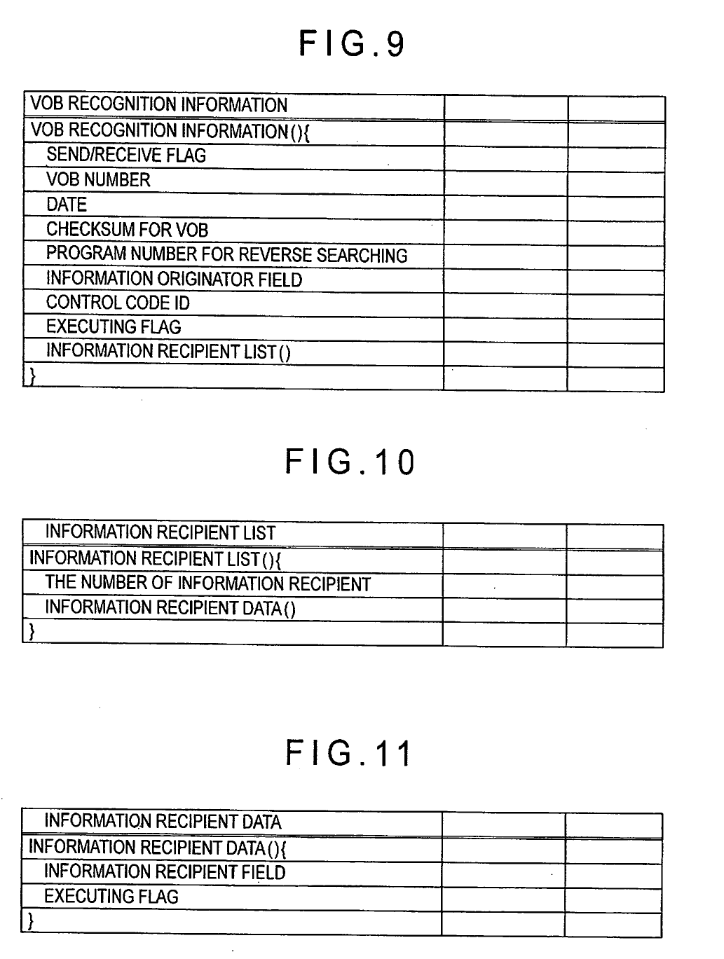

FIG. 9 is a schematic diagram showing the structure of the “VOB recognition information” in a table form.

In FIG. 9, the “VOB recognition information” is a group of information for recognizing the VOB, and has a field called as “transmitting and receiving flag”, a field called as “VOB number”, a field called as “date”, a field called as “checksum for VOB”, a field called as “program number for reverse searching”, a field called as “information originator field”, a field called as “control code ID”, a field called as “executing flag”, and a field called as “information recipient list”.

Herein, the “transmitting and receiving flag” is shown as 1 in the case that the information is the program recognition information transmitted from himself/herself, and the “transmitting and receiving flag” is shown as 0 in the case that the information is the received program recognition information.

The “VOB number” is the number of the VOB to be the object.

The “date” is the date being described in the VOB information, and is described by both “VOB_REC_TM” and “OB_REC_TM_SUB”.

The “checksum for VOB” is a checksum for the VOB information, and for the whole “M_VOBI”, and the system of “CRC32” is used. The checksum is one of the methods for checking whether transmitted data have some errors or not. And the sum of the data is calculated in advance, and when the data are transmitted, the data and the sum are transmitted. And the receiving side calculates the sum of the received data and compares the calculated sum with the sum calculated at the transmitting side. When some errors exist in the transmitted data, the compared result does not become equal, and the error can be detected.

The “program number for reverse searching” is the program number indicating the VOB.

The “information originator field” shows a code (−1) indicating himself/herself, in the case that the transmitting and receiving flag is 1, and in the case that the transmitting and receiving flag is 0, shows an e-mail address showing the destination, which is in form of the number of letters+characters.

The “control code ID” is an ID identifying the control that became the trigger for generating the VOB recognition information, and this control code is assigned uniquely by the originator of the source. By the combination of the originator of the information source and the control code ID, the control that became the trigger for generating the VOB recognition information can be identified.

The “executing flag” is a flag for identifying that himself/herself executed the control completely, and 1 is shown in the case that the execution of the control ended, and 0 is shown in the case that the control has not been executed.

The “information recipient list” enumerates the recipients to whom the VOB recognition information was transmitted by multi-address communication.

FIG. 10 is a schematic diagram showing the structure of the “information recipient list” in a table form.

In FIG. 10, the “information recipient list” has a field called as “the number of information recipient” and a field called as “information recipient data”.

The “the number of information recipient” is the number of persons who receive information, and in the embodiment of the present invention, the number is 2.

FIG. 11 is a schematic diagram showing the structure of the “information recipient data” in a table form.

In FIG. 11, the “information recipient data” has a field called as “information recipient field” and a field called as “executing flag”.

The “information recipient field” shows the recipient by multi-address communication as their e-mail addresses, and shows as the number of letters+characters.

The “executing flag” shows 1 in the case that the recipient executed, and shows 0 in the case that the recipient has not executed.

[Processes of Video Recording by Multi-address Communication]

Next, processes of a video recording by multi-address communication are explained.

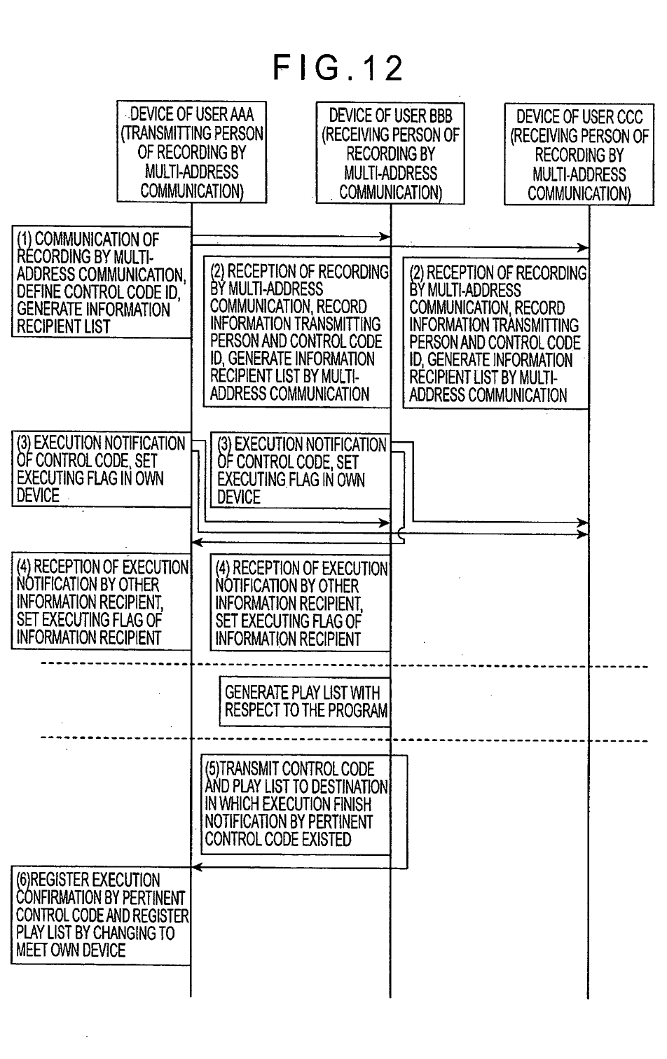

FIG. 12 is an operation sequence chart of the three devices for information processing 300.

In FIG. 12, first, (1) a user AAA transmits a video recording by multi-address communication to users BBB and CCC.

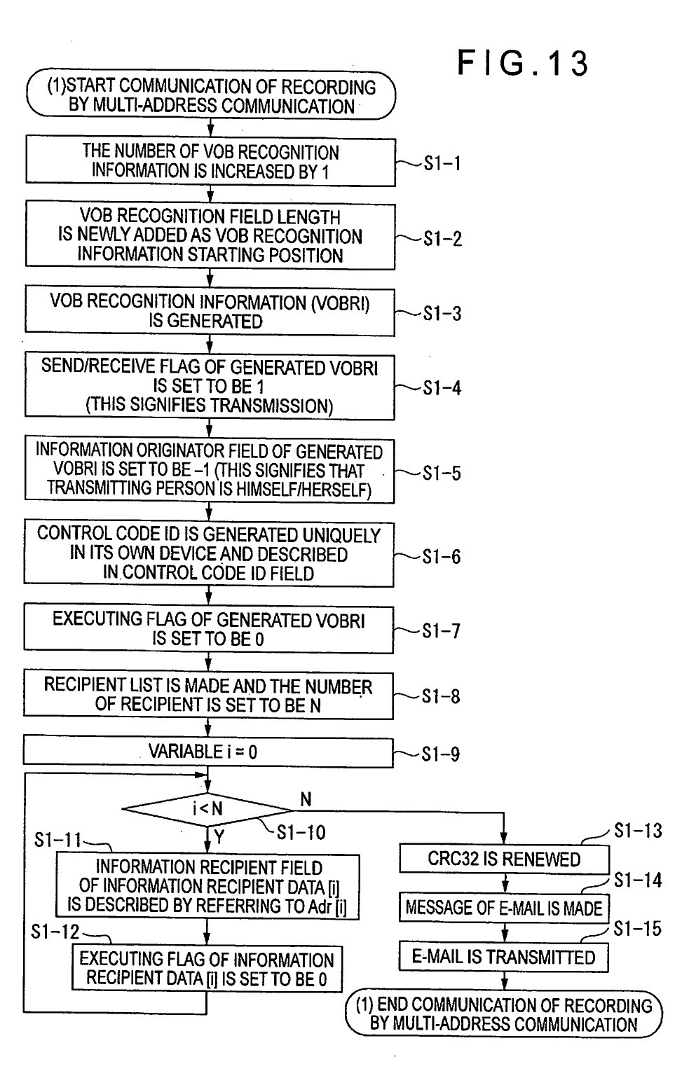

The processes of the communication of this video recording by multi-address communication are shown in the flowchart of FIG. 13.

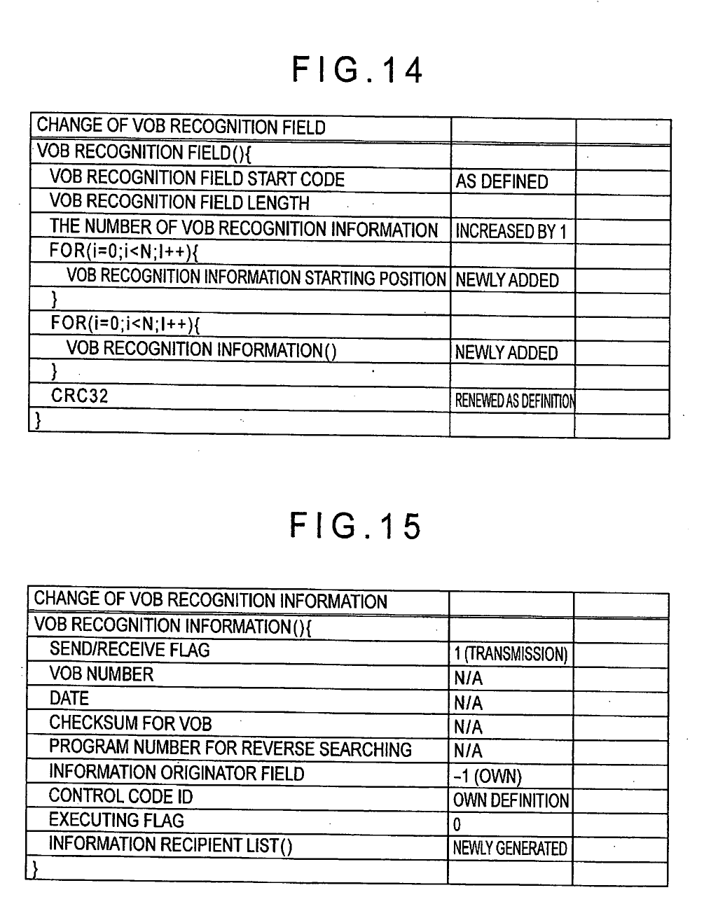

In FIG. 13, when the communication of the recording by multi-address communication is started, the number of VOB recognition information is increased by 1 (step S1-1). The VOB recognition field length is newly added as the VOB recognition information starting position (step S1-2), and VOB recognition information is generated (step S1-3). By the processes mentioned above, the state of the “VOB recognition field” is changed from the state shown in FIG. 8 to the state shown in FIG. 14. Incidentally, the “VOB recognition field” has been generated beforehand.

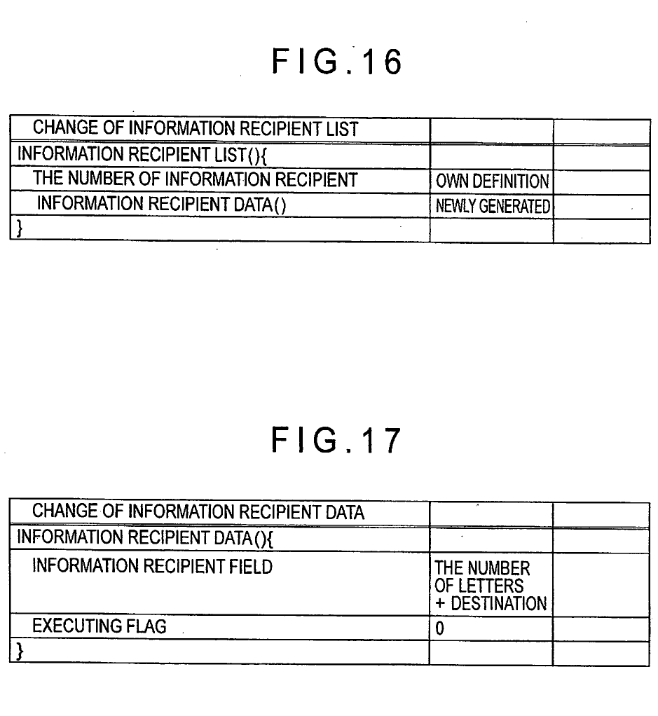

After this, the generated VOB recognition information (VOBRI) is transmitted, and the transmitting and receiving flag is set to be 1 (step S14), and the information originator field of the generated VOB recognition information (VOBRI) is set to be 1 and it is recorded that the user AAA himself is the originator (step S1-5). And a control code ID is generated uniquely in its own device, and the control code ID is described in the control ID code field (step S1-6), and the executing flag of the generated VOBRI is set to be 0 (step S1-7). Further, a recipient list is made and the number of recipient is set to be N (2 in the embodiment) (step S1-8). With this, the state of the “VOB recognition information” is changed from the state shown in FIG. 9 to the state shown in FIG. 15, the state of “information recipient list” is changed from the state shown in FIG. 10 to the state shown in FIG. 16, and the state of “information recipient data” is changed from the state shown in FIG. 11 to the state shown in FIG. 17.

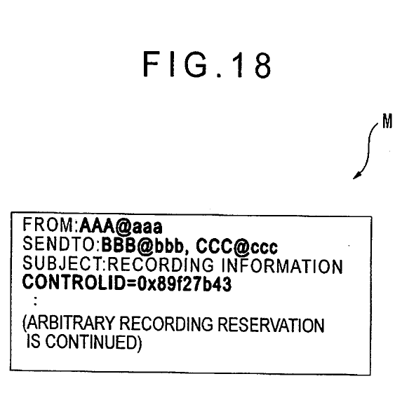

Herein, a variable i is set to be 0 (step S1-9), and the variable i and the number of recipient N are compared (step S1-10). In the case that the variable i is smaller than N, the information recipient field of the information recipient data [i] is described by referring to an Adr [i] (recipient address) (step S1-11), and the executing flag of the information recipient data [i] is set to be 0 (step S1-12). On the contrary, in the case that the variable i is not smaller than N, the CRC32 is renewed (step S1-13), and a message on a screen of an e-mail M is made (step S1-14). As shown in FIG. 18, this message on the screen signifies that the message is sent from the user AAA@aaa being the sender to the users BBB@bbb and CCC@ccc being the destinations. In the head of the main message, Control ID is described, the Control ID is the control code ID assigned uniquely by the sender AAA@aaa. In the next routine, by having received this e-mail M, the sender by multi-address communication is specified from the tag of “From:”, and the recipient by multi-address communication are specified from the tag of “Send To:”. Further, from the row of the “Control ID”, the control code ID can be obtained.

After this, the e-mail M is transmitted (step S1-15), and the video recording by multi-address communication ends.

In FIG. 12, after finishing the communication from the user AAA at the recording by multi-address communication to the users BBB and CCC, (2) the users BBB and CCC receive by multi-address communication. That is, the reception of recording by multi-address communication is executed.

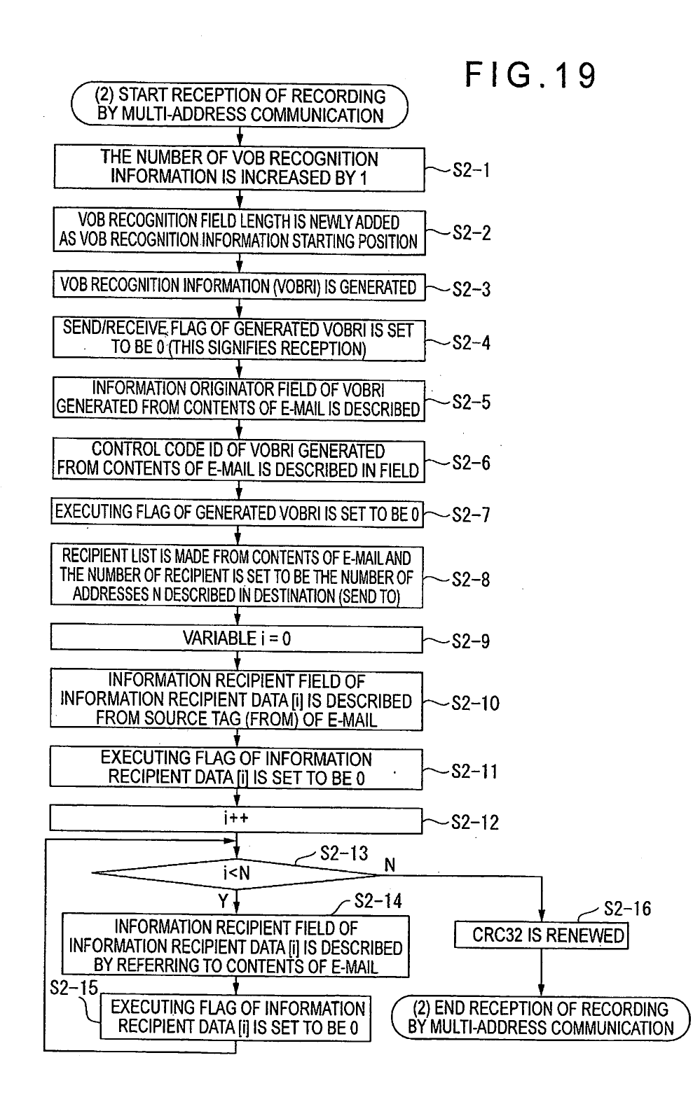

The processes of the reception of the video recording by multi-address communication are shown in the flowchart of FIG. 19.

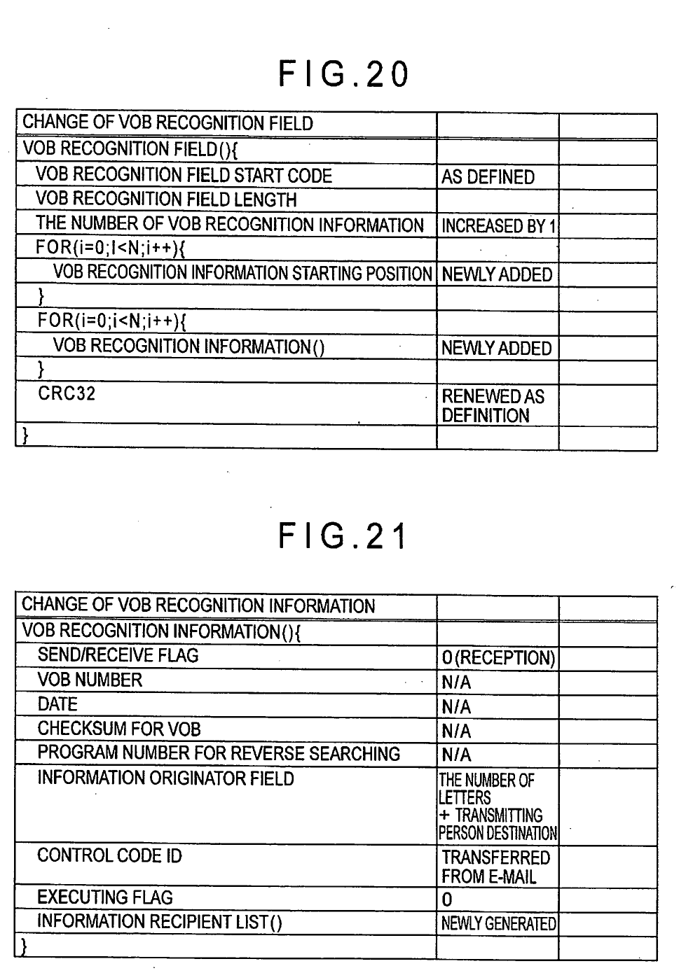

In FIG. 19, when the reception of the recording by multi-address communication is started, the number of VOB recognition information is increased by 1 (step S2-1). The VOB recognition field length is newly added as the VOB recognition information starting position (step S2-2), and VOB recognition information is generated (step S2-3). By the processes mentioned above, the state of the “VOB recognition field” is changed from the state shown in FIG. 8 to the state shown in FIG. 20.

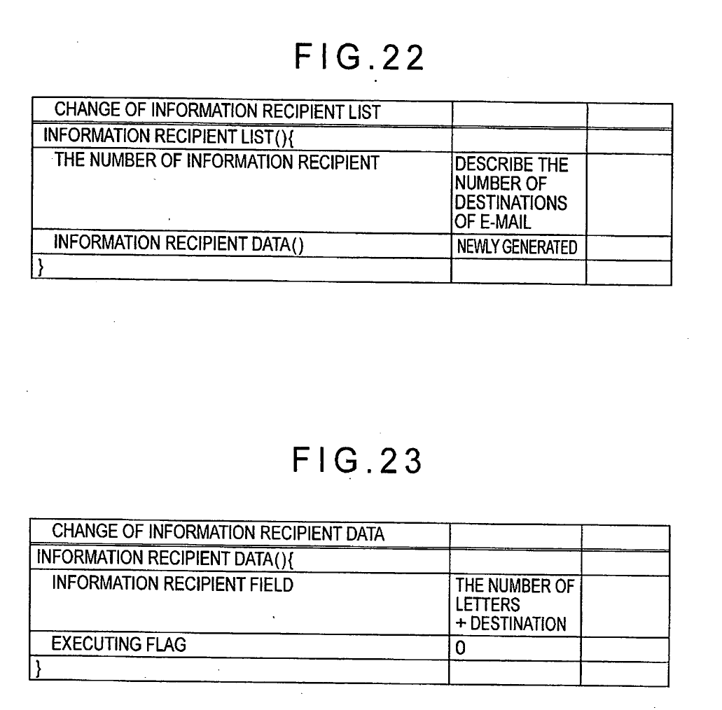

After this, the generated VOB recognition information (VOBRI) is transmitted, and the transmitting and receiving flag is set to be 0 (step S2-4), and the information originator field of the VOB recognition information (VOBRI) generated from the contents of the e-mail is described (step S2-5). Further, the control code ID of the VOBRI generated from the contents of the e-mail M is described in the field (step S2-6), and the executing flag of the generated VOBRI is set to be 0 (step S2-7). Further, a recipient list is made from the contents of the e-mail M and the number of recipient is set to be the number of addresses N described in the destination (Send To) (step S2-8). With this, the state of the “VOB recognition information” is changed from the state shown in FIG. 9 to the state shown in FIG. 21, the state of “information recipient list” is changed from the state shown in FIG. 10 to the state shown in FIG. 22, and the state of “information recipient data” is changed from the state shown in FIG. 11 to the state shown in FIG. 23. Incidentally, the number N of the information recipient list is the number that 1 is added to the number of addresses 1 described in the destination.

After this, a variable i is set to be 0 (step S2-9), the information recipient field of the information recipient data [i] is described from the source tag of the e-mail M (step S2-10), and the executing flag of the information recipient data [i] is set to be 0 (step S2-11). This process is required because the transmitting person must be added to the list of multi-address communication for the routine followed this.

Next, the previous processes are repeated by changing the variable i (step S2-12), and the variable i and the number of recipient N are compared (step S2-13) with each other. In the case that the variable i is smaller than N, the information recipient field of the information recipient data [i] is described by referring to an Adr [i] (recipient address) (step S2-14), and the executing flag of the information recipient data [i] is set to be 0 (step S2-15), and the process returns to the step S2-13. On the contrary, in the case that the variable i is not smaller than N, the CRC32 is renewed (step S2-16), and the reception of the video recording by multi-address communication ends.

After this, as shown in FIG. 12, (3) the notification of the control code is executed among three devices for information processing 300. Herein, a state in which the recording by multi-address communication has not been received at the device for information processing 300 of the user CCC is explained.

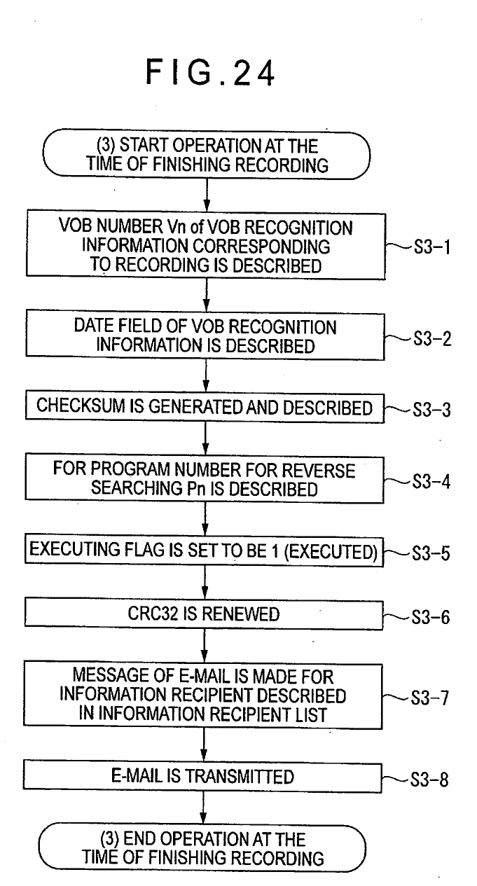

The processes of the notification of the control code are shown in the flowchart of FIG. 24.

In FIG. 24, when the operation by the control code is started after finishing the recording operation, a VOB number Vn of the VOB recognition information corresponding to the recording is described (step S3-1), and the date field of the VOB recognition information is described (step S3-2), and the checksum is generated and described (step S3-3). After this, the program number for reverse searching Pn is described (step S3-4), and the executing flag is set to be “1” which shows the process was executed (step S3-5). And the CRC32 is renewed (step S3-6), and the message on the screen of the e-mail M is made for the information recipient described in the information recipient list (step S3-7).

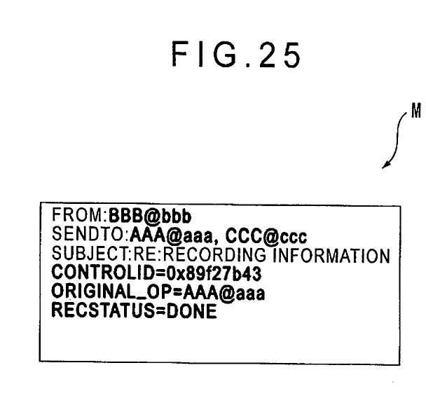

The message on the screen of the e-mail M is shown in FIG. 25. In FIG. 25, the message on the screen of the e-mail M is the reply to the e-mail M shown in FIG. 18, and in order to reply, the “From: ” and “Send To:” have been changed in FIG. 25. At the head of the main message, the description of “Control ID” exists, and in the next row, the information source is specified (at the embodiment, AAA@aaa), and in the further next low, the description of “ORIGINAL_OP=” exists, and below this row, the description of “RECSTATUS=DONE” showing that the process was executed exists. With this, the user of the BBB@bbb who replied to the e-mail M can inform that the user BBB executed the reservation based on the recording reservation information identifying by the control code ID. On the other hand, in the next routine, by receiving this e-mail M, the user AAA can recognize that the user BBB executed this operation and can change his/her own management structure.

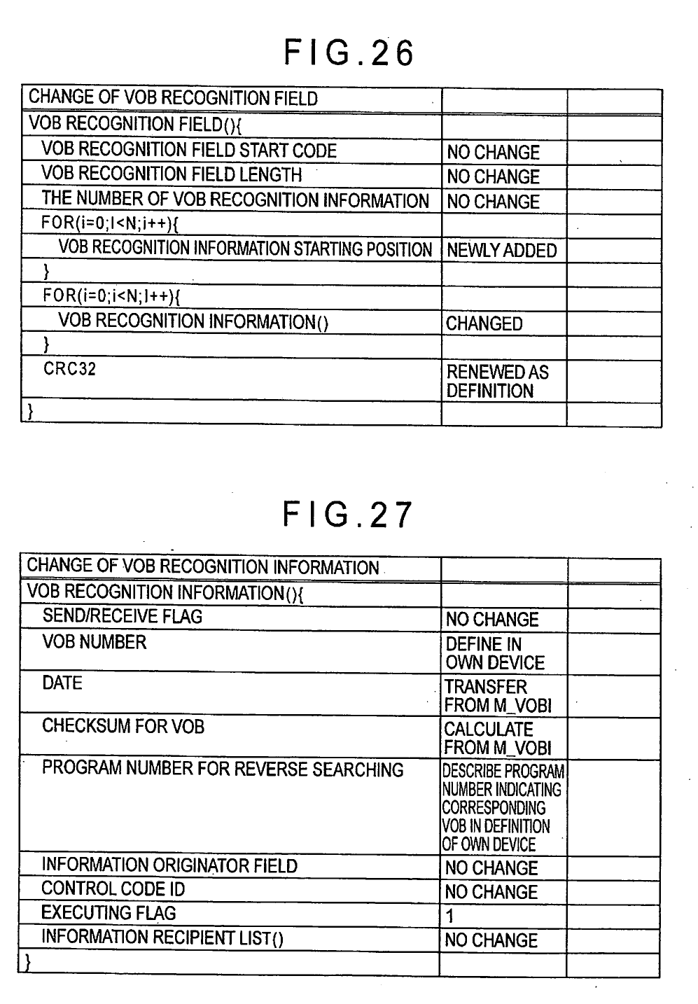

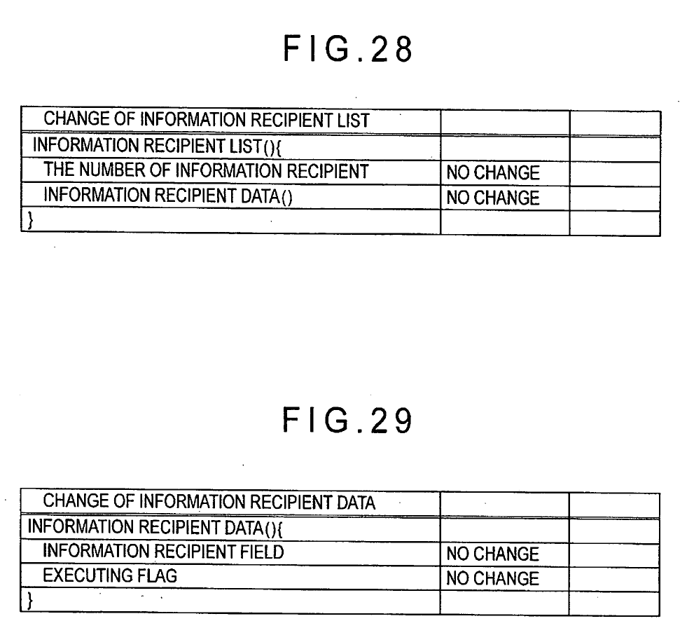

By the processes mentioned above, the state of the “VOB recognition field” is changed from the state shown in FIG. 8 to the state shown in FIG. 26, the state of “VOB recognition information” is changed from the state shown in FIG. 9 to the state shown in FIG. 27, the state of “information recipient list” is changed from the state shown in FIG. 10 to the state shown in FIG. 28, and the state of “information recipient data” is changed from the state shown in FIG. 11 to the state shown in FIG. 29.

After this, the e-mail M is transmitted (step S3-8), and the operation ends at the time when the video recording ends.

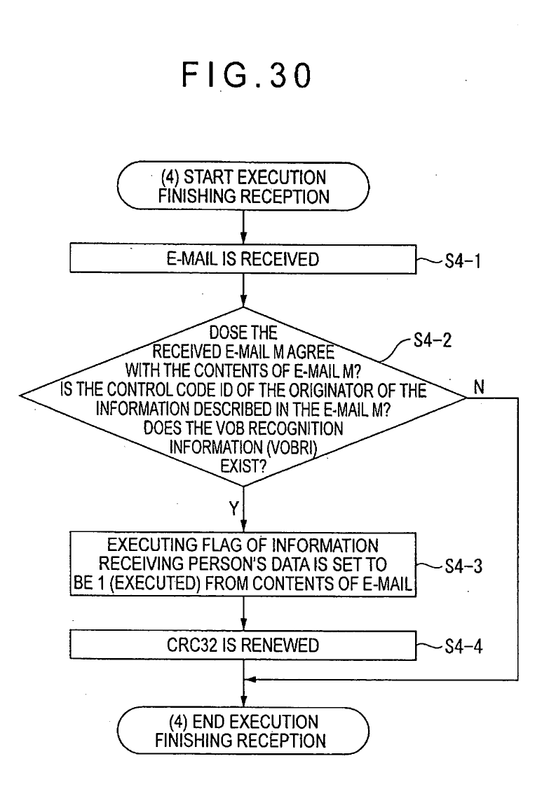

After this, as shown in FIG. 12, (4) other information recipient receive execution communication. These processes are shown in a flowchart of FIG. 30.

In FIG. 30, when the execution finishing reception is started, the e-mail M is received (step S4-1), and it is judged whether the received e-mail M agree with the contents thereof or not, whether the control code ID of the originator of the information is described therein or not, and whether the VOB recognition information (VOBRI) exists or not (step S4-2). In the case that the judgment was satisfied, the executing flag of the information recipient data is set to be “1”, which means that the executing flag of the information recipient was executed base on the contents of the e-mail M (step S4-3), and the CRC32 is renewed (step S4-4). With this, the execution finishing reception ends.

On the other hand, it is judged whether the received e-mail M agree with the contents thereof or not, whether the control code ID of the originator of the information is described therein or not, and whether the VOB recognition information (VOBRI) exists or not (step S4-2), in the case that the judgment was not satisfied, that is, even one of the conditions was not satisfied, the execution finishing reception ends immediately.

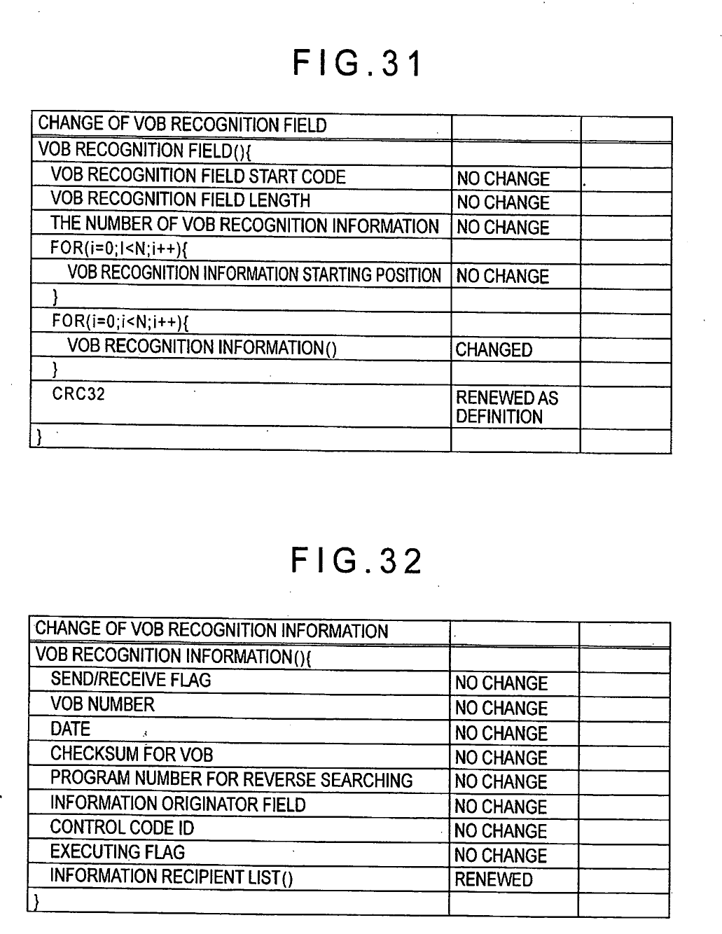

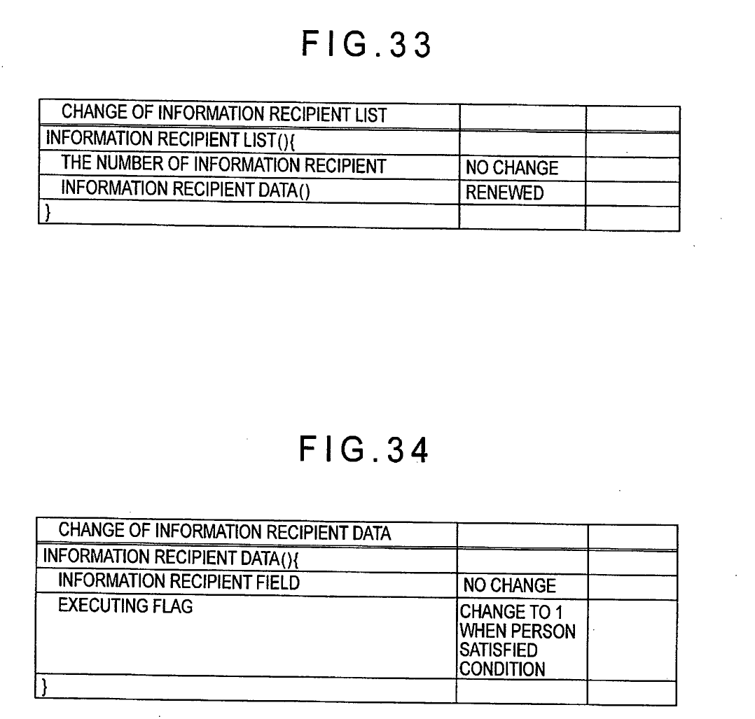

By the processes mentioned above, the state of the “VOB recognition field” is changed from the state shown in FIG. 8 to the state shown in FIG. 31, the state of “VOB recognition information” is changed from the state shown in FIG. 9 to the state shown in FIG. 32, the state of “information recipient list” is changed from the state shown in FIG. 10 to the state shown in FIG. 33, and the state of “information recipient data” is changed from the state shown in FIG. 11 to the state shown in FIG. 34.

After this, as shown in FIG. 12, at the device for information processing 300 of the user BBB, the play list was made, and after this, (5) the control code ID and the play list are transmitted to the user AAA having the original control code ID.

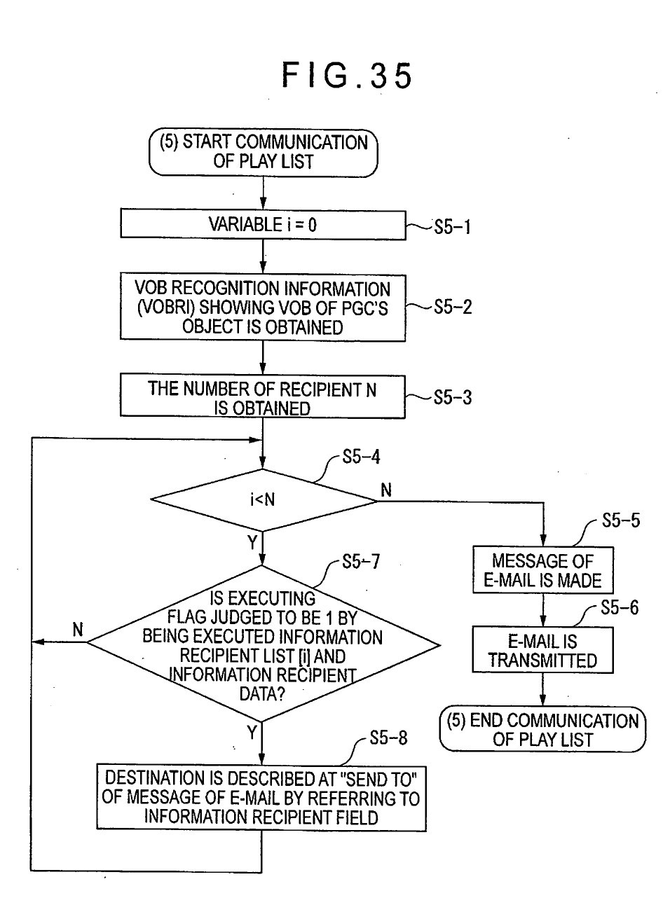

These processes are shown in FIG. 35. In FIG. 35, when the communication of the play list is started, the variable i is set to be 0 (step S5-1), and the VOB recognition information (VOBRI) showing the VOB of the PGC's object is obtained (step S5-2), and the number of information recipient N is obtained (step S5-3).

The variable i and the number of information recipient N are compared (step S5-4), and in the case that the variable i is not smaller than the N, the message on the screen of the e-mail M is made (step S5-5).

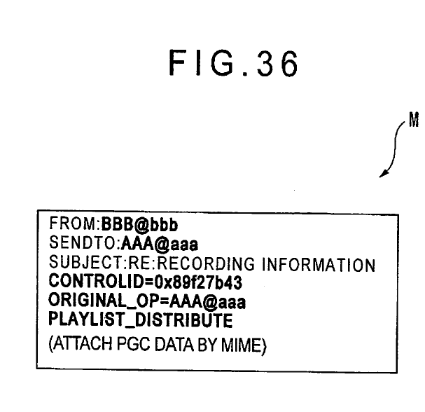

The message on the screen of the e-mail M is shown in FIG. 36. In FIG. 36, at the head of the main message, the description “Control ID=” exists, and in the next row, the description “ORIGINAL_OP=” showing the information source exists. Below the row, a character string such as “PLAYLIST_DISTRIBUTE” is described, and this shows that this is the e-mail M to execute the communication of the PGC. The PGC data is handled as binary data, therefore, the PGC data are transmitted based on an existing method for attaching the binary data to an e-mail (for example, MINE). On the receiving side, the PGC data are developed in a medium of its own by interpreting the binary data followed the character string.

When the e-mail M was made, the e-mail M is transmitted from the user BBB to the user AAA (step S5-6), and the communication of the play list ends.

On the contrary, in the case that the variable i is smaller than the N in the step S5-4, it is judged whether the executing flag is 1 or not by having the information recipient list [i] and the information recipient data executed (step S5-7). In the case that the executing flag became 1, the destination is described at the “Send To” of the message on the screen of the e-mail shown in FIG. 36 by referring to the information receiving person field (step S5-8), and the process returns to the step S5-4. In the case that the executing flag did not become 1, the process returns to the step S5-4 immediately.

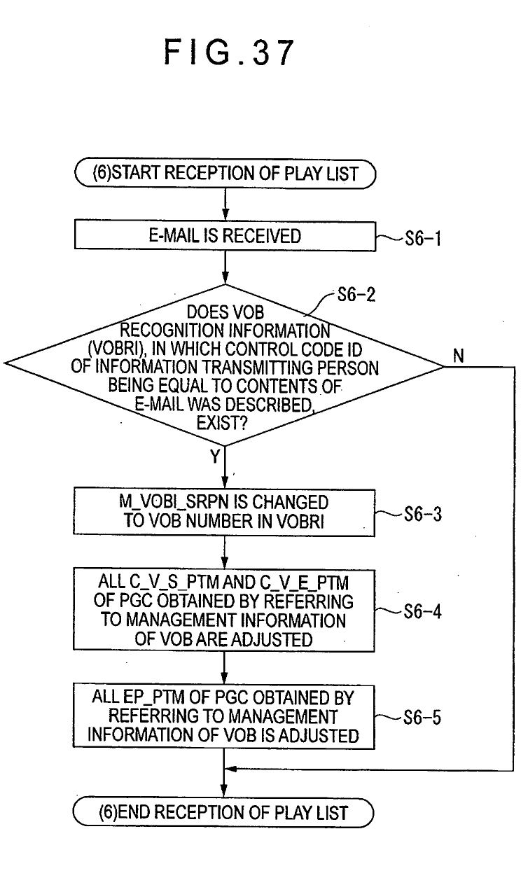

After this, as shown in FIG. 12, (6) the user AAA receives the play list, and confirms the execution by the control code ID. The processes of the reception of the play list are shown in the flowchart of FIG. 37.

In FIG. 37, the reception of the play list is started. First, the e-mail M is received (step S6-1), and it is judged whether the VOB recognition information (VOBRI), in which the control code ID of the information transmitting person was described, being equal to the contents of this e-mail, exists or not (step S6-2). In the case that the VOB recognition information (VOBRI) exists, “M_VOBI_SRPN” is changed to the VOB number in the VOBRI (step S6-3), all “C_V_S_PTM” and “C_V_E_PTM” of the PGC obtained by referring to the management information of the VOB are adjusted (step S6-4) and all “EP_PTM” of the PGC obtained by referring to the management information of the VOB is adjusted (step S6-5), and the reception of the play list ends. On the other hand, in the case that it is judged that the VOB recognition information (VOBRI) does not exist, the reception of the play list ends immediately.

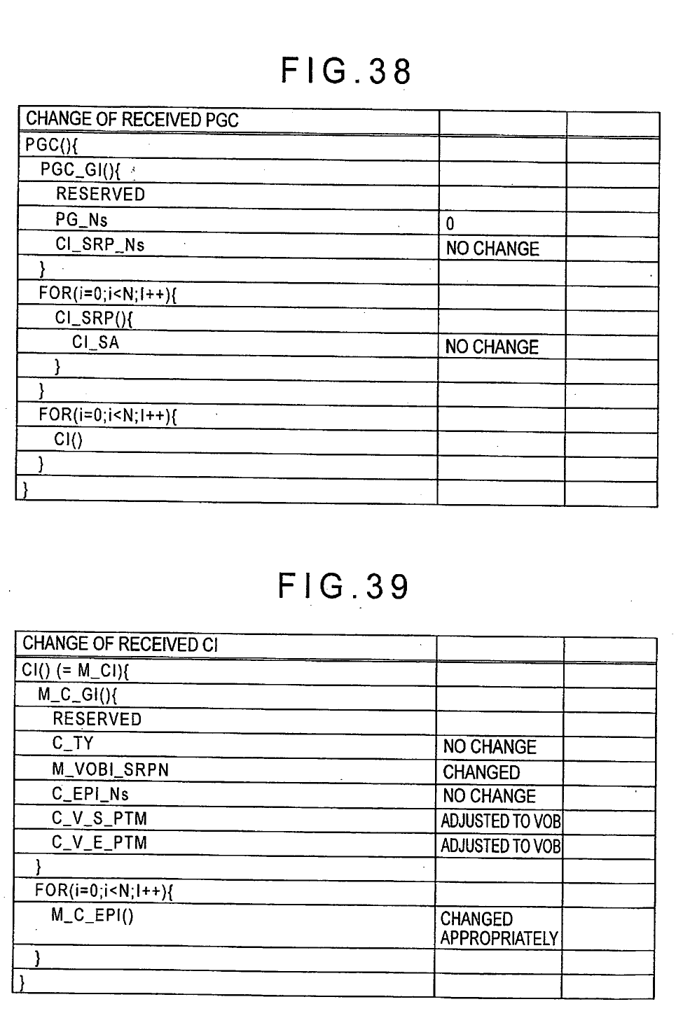

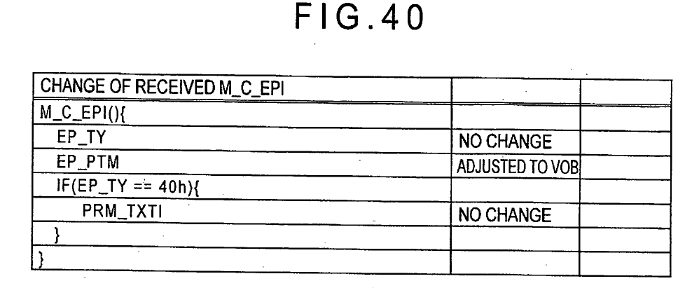

By the processes mentioned above, the state of the “structure of PGC” is changed from the state shown in FIG. 5 to the state shown in FIG. 38, the state of “structure of CI” is changed from the state shown in FIG. 6 to the state shown in FIG. 39, and the state of “structure of M_C_EPI” is changed from the state shown in FIG. 7 to the state shown in FIG. 40.

[Effects of Device and System]

According to the present invention, the device for information processing 300 comprises the DVD drive 420 that records data being able to be reproduced in a DVD, the designated information generator 431 that generates a play list having information specifying data for specifying information, reproducing section data and reproducing order data in the specified information, the designated information transmitter 432 that transmits the play list to a set destination(s), the destination information register 434 in which destination information has been registered, the designated information receiver 433 that receives a play list transmitted from other device(s) for information processing 300, the information existence judging section 435 that judges whether information specified by the information specifying data in the received play list has been recorded in the DVD drive 420 or not, and the information reproducer 436 that reproduces information based on the received play list in the case that the information existence judging section 435 confirmed that the information has been recorded. Therefore, in the case that a play list generated by a user is delivered to other user(s) and it is confirmed that the specified information by the play list has been recorded in the DVD drive 420, the information is reproduced based on the received play list, consequently, information edited by one user can be utilized by other user(s), without using a server. Therefore, the system can be worked in a framework of DVD-VR, even omitting the server, and the total cost of the system can be decreased, and information can be actively exchanged in a small group being composed of authenticated users.

And also, the DVD drive 420 records a program received at the antenna 321 and program specified data specifying this program in a DVD being a recording medium. In the case that the program specified data have been recorded in the DVD drive 420 as the information specified data, the program is reproduced based on the received play list. Therefore, by exchanging the play list of broadcast programs, information with respect to the broadcast programs can be actively exchanged among the users.

The program specified data comprises channel data specifying a broadcast station, program starting data specifying the starting date and time of a program, and program ending data specifying the ending date and time of the program. Therefore, a broadcast program can be surely specified from the channel data among the devices for information processing 300, and information of the broadcast programs can be exchanged among users.

The device for information processing 300 comprises the recording instruction information receiver 437 that receives recording instruction information in which recording instruction data for instructing to record a program and identifying data for identifying recording control data are included. The DVD drive 420 can record a designated program and the identifying data (control code ID) in the DVD, based on the received recording instruction information. And in the case that the identifying data have been recorded in the DVD drive 420 as the program specifying data, the program is reproduced based on the received play list. Therefore, among the devices for information processing 300, information with respect to the broadcast programs can be actively exchanged among the users, by exchanging the play list with respect to the broadcast programs among the users by using the identifying data.

And also, at the device for information processing 300, a framework of MNFI being a region that can be used freely by each of manufacturers at DVD-VR is used for the play list, therefore, it is not necessary to change the DVD-VR standard.

The recording instruction information includes originator data showing originator having transmitted the recording instruction information and destination data having sender data showing sender who sent the recording instruction information. And the device for information processing 300, in the CPU 430, provides the information recording completion data transmitter 438 that transmits information recording completion data having process completion data and identifying data in the recording instruction information to each of the destinations recorded in the destination data, when an information recording process was executed and completed based on the recording instruction information. Further, the device for information processing 300, in the CPU 430, provides the information recording completion data receiving memory 439 that receives information recording completion data from other device(s) for information processing 300 and memorizes originator data and identifying data. The designated information transmitter 432 transmits the play list by setting the originator data transmitted the information recording completion data having the identifying data corresponding to the information identifying data of the play list to be transmitted as the destination. Therefore, the play list recorded by one device for information processing 300 can be surely transmitted to other devices for information processing 300, and the play list can be surely exchanged among the plural devices for information processing 300.

PGC data are transmitted to a user by attaching to an e-mail M by using an attaching file such as MINE, therefore, exchanging the PGC data among the plural devices for information processing 300 can be executed easily.

And also, the DVD drive 420, the designated information generator 431, the designated information transmitter 432, the designated information receiver 433, the destination information register 434, the information existence judging section 435, and the information reproducer 436 are built in one device for information processing 300 without disposing in other devices, therefore, the device for information processing 300 can be formed as one compact device.

The video recording system by multi-address communication 100 is composed of the plural devices for information processing 300 and the network 200 for connecting these devices for information processing 300 to one another. Therefore, a server can be omitted from the system and the system in which the total cost is reduced can be provided.

The present invention is not to be restricted by the above-mentioned embodiment, and the embodiment of the present invention can be changed or modified without departing from the scope and spirit of the present invention, and the changed or modified ones are included in the present invention.

For example, in the embodiment of the present invention, a DVD is used as the recording medium, and a DVD recording and reproducing device is used as the device for information processing 300. However, in the present invention, instead of using the DVD, a recording medium such as a hard disk, a semiconductor memory, and a video tape can be used.

And also, in the embodiment of the present invention, the structure, in which three devices for information processing 300 are connected to one another via the network 200, was explained. However, the structure is not limited to the structure mentioned above. That is, for example, a structure, in which a LAN cable is used for the connection among the devices for information processing 300, can be used. By this structure, a setting process of a group recording reservation can be executed without using the network 200. With this structure, a large amount of time for the setting process of the recording reservation, caused by, for example, the congestion of the network 200, which is not a factor directly connecting to the device for information processing 300, can be avoided. Consequently, a recording system by multi-address communication, in which the setting process of the recording reservation is always possible in a short time, can be provided.

Furthermore, the number of the devices for information processing 300 is not limited to three, the number can be two, or four or more.

As each of the devices for information processing 300, a video recording device using the DVD-VR system, which can record TV programs, was used. However, as each of the devices for information processing 300, a stereo recorder, which can record radio programs, can be used, in this case, the present invention can apply to a sound recording system by multi-address communication, by using the stereo recorders.

Furthermore, by using a computer as each of the devices for information processing 300, the present invention can apply to a content recording system by multi-address communication, in which contents being delivered via the network 200 are recorded.

And also, as the system for information processing, the structure of the video recording system by multi-address communication 100, in which each of the devices for information processing 300 are connected to one another via the network 200, was explained. In this structure, a computer can be used for operation, and the operation can be executed by a computer program, and the computer program can be stored in a recording medium.

And when the present invention is executed, the actual structure and the actual processes can be changed or modified within the scope and spirit of the present invention.

[Effects of Embodiment]

As mentioned above, according to the embodiment of the present invention, the device for information processing 300 comprises the DVD drive 420 that records data being able to be reproduced in a DVD, the designated information generator 431 that generates a play list having information specifying data for specifying information, reproducing section data and reproducing order data in the specified information, the designated information transmitter 432 that transmits the play list to a set destination(s), the destination information register 434 in which destination information has been registered, the designated information receiver 433 that receives a play list transmitted from other device(s) for information processing 300, the information existence judging section 435 that judges whether information specified by the information specifying data in the received play list has been recorded in the DVD drive 420 or not, and the information reproducer 436 that reproduces information based on the received play list in the case that the information existence judging section 435 confirmed that the information has been recorded. Therefore, information edited by one user can be utilized by other user(s), without using a server. Consequently, the system can be worked in a framework of DVD-VR, even omitting the server, and the total cost of the system can be decreased, and information can be actively exchanged in a small group being composed of authenticated users.

The priority application Number JP2003-382925 upon which this patent application is based is hereby incorporated by reference.

1. A device for information processing in a plurality of devices for information processing, which are connected to one another via a network, comprising:
an information recorder for recording information being able to be reproduced in an information recording medium;
a designated information generator for generating designated information having information specifying data for specifying information, reproducing section data and reproducing order data in the specified information;
a designated information transmitter for transmitting the generated designated information to a destination being set;
a destination information register in which destination information has been registered;
a designated information receiver for receiving designated information transmitted from other devices for information processing;
an information existence judging section for judging whether the information being specified by the information specifying data of the received designated information has been recorded in the information recorder or not; and
an information reproducer for reproducing information based on the received designated information, in the case that the information existence judging section has confirmed that the information had been recorded.

2. The device for information processing according to claim 1, further comprising:
a broadcast program receiver for receiving broadcast programs on the air, wherein:
the information recorder records a broadcast program(s) received at the broadcast program receiver and program specifying data for specifying this broadcast program in the information recording medium, and
the information specifying data are the program specifying data.

3. The device for information processing according to claim 2, wherein:
the program specifying data is composed of channel data for specifying broadcasting stations, program starting data specifying broadcast program starting date and time, and program ending data specifying broadcast program ending date and time.

4. The device for information processing according to claim 1, further comprising:
a broadcast program receiver for receiving broadcast programs; and
a recording instruction information receiver for receiving recording instruction information including recording control data for the instructing of recording a broadcast program(s) and identifying data for identifying the recording control data, wherein:
the information recorder is configured such to be capable of recording a designated broadcast program(s) and the identifying data in the information recording medium based on the received recording instruction information, and
the information specifying data are the identifying data.

5. The device for information processing according to claim 4, wherein:
the recording instruction information includes originator data showing originator having transmitted the recording instruction information and destination data having sender data showing a sender having sent the recording instruction information, and
the information recorder, comprising:
an information recording completion data transmitter for transmitting information recording process completion data having the identifying data in the recording instruction information and process completion data to each of the destinations recorded in the destination data, when an information recording process was executed and completed based on the recording instruction information; and
an information recording process completion data receiving memory for receiving the information recording completion data from other device(s) for information processing and memorizing the originator data and the identifying data, wherein:
the designated information transmitter sets the sender data of the sender who has transmitted the information recording process completion data, which has the identifying data corresponding to the information specifying data of transmitting designated information, as the destination, and transmits the designated information.

6. The device for information processing according to claim 1, wherein:
the information recorder, the designated information generator, the designated information transmitter, the destination information register, the designated information receiver, the information existence judging section, and the information reproducer are built in one device.

7. A system for information processing, comprising:
a plurality of devices for information processing connected to one another via a network, and a network for connecting these devices for information processing to one another, each device further comprising:
an information recorder for recording information being able to be reproduced in an information recording medium;
a designated information generator for generating designated information having information specifying data for specifying information, reproducing section data and reproducing order data in the specified information;
a designated information transmitter for transmitting the generated designated information to a destination(s) being set;
a destination information register in which destination information has been registered;
a designated information receiver for receiving designated information transmitted from other devices for information processing;
an information existence judging section for judging whether the information being specified by the information specifying data of the received designated information has been recorded in the information recorder or not; and
an information reproducer for reproducing information based on the received designated information, in the case that the information existence judging section has confirmed that the information had been recorded.

8. A method for information processing being executed among a plurality of devices for information processing connecting to one another via a network, comprising the steps of:
receiving designated information having information specifying data for specifying information, reproducing section data and reproducing order data in the specified information;
judging whether information being specified by the information specifying data of the received designated information has been recorded or not in an information recorder for recording information being able to be reproduced in an information recording medium; and
reproducing information based on the received designated information, when it was confirmed that the information had been recorded.

9. A method for information processing being executed among a plurality of devices for information processing connecting to one another via a network, wherein:
at one device in the plurality of devices for information processing, comprising the steps of:
generating designated information having information specifying data for specifying information, reproducing section data and reproducing order data in the specified information; and
transmitting the generated designated information to a destination(s) being other device(s) in the plurality of devices for information processing, and
at other device(s) in the plurality of devices for information processing, comprising the steps of:
registering information of the destination information;
receiving the designated information transmitted from the one device,
judging whether information being specified by the information specifying data of the received designated information has been recorded or not in an information recorder for recording information being able to be reproduced in an information recording medium; and
reproducing information based on the received designated information, when it was confirmed that the information had been recorded.

10. The method for information processing according to claim 8, wherein:
the information recorder records a broadcast program(s) received by a broadcast receiver and program specifying data specifying the broadcast program(s).

11. The method for information processing according to claim 9, wherein:
the information recorder records a broadcast program(s) received by a broadcast receiver and program specifying data specifying the broadcast program(s).

12. A program for information processing executing a method for information processing, which is adapted to be executed among a plurality of devices for information processing connecting to one another via a network, wherein the method comprises the steps of:
receiving designated information having information specifying data for specifying information, reproducing section data and reproducing order data in the specified information;
judging whether information being specified by the information specifying data of the received designated information has been recorded or not in an information recorder for recording information being able to be reproduced in an information recording medium; and
reproducing information based on the received designated information, when it was confirmed that the information had been recorded.

13. A program for information processing executing a method for information processing, which is adapted to be executed among a plurality of devices for information processing connecting to one another via a network,
wherein the method comprises, at one device in the plurality of devices for information processing, the steps of:
generating designated information having information specifying data for specifying information, reproducing section data and reproducing order data in the specified information; and
transmitting the generated designated information to a destination(s) being other device(s) in the plurality of devices for information processing, and
wherein the method comprises, at other device(s) in the plurality of devices for information processing, the steps of:
registering information of the destination information;
receiving the designated information transmitted from the one device,
judging whether information being specified by the information specifying data of the received designated information has been recorded or not in an information recorder for recording information being able to be reproduced in an information recording medium; and
reproducing information based on the received designated information, when it was confirmed that the information had been recorded.

14. A recording medium storing a program for information processing in a manner readable by a computer, the program executing a method for information processing, which is adapted to be executed among a plurality of devices for information processing connecting to one another via a network, wherein the method comprises the steps of:
receiving designated information having information specifying data for specifying information, reproducing section data and reproducing order data in the specified information;
judging whether information being specified by the information specifying data of the received designated information has been recorded or not in an information recorder for recording information being able to be reproduced in an information recording medium; and
reproducing information based on the received designated information, when it was confirmed that the information had been recorded.

15. A recording medium storing a program for information processing in a manner readable by a computer, the program executing a method for information processing, which is adapted to be executed among a plurality of devices for information processing connecting to one another via a network,
wherein the method comprises, at one device in the plurality of devices for information processing, the steps of: generating designated information having information specifying data for specifying information, reproducing section data and reproducing order data in the specified information; and
transmitting the generated designated information to a destination(s) being other device(s) in the plurality of devices for information processing, and
wherein the method comprises, at other device(s) in the plurality of devices for information processing, the steps of:
registering information of the destination information;
receiving the designated information transmitted from the one device,
judging whether information being specified by the information specifying data of the received designated information has been recorded or not in an information recorder for recording information being able to be reproduced in an information recording medium; and
reproducing information based on the received designated information, when it was confirmed that the information had been recorded.
